(19) United States
(12) Patent Application Publication
(10) Pub. No.: US 2007/0072493 A1
(43) Pub. Date: Mar. 29, 2007

(54) Vertebral osteosynthesys device

(76) Inventors: Denys Sournac, Reyrieux (FR); Jean-Philippe Caffiero, Lyon (FR); Francois Carlier, Guerande (FR)

Correspondence Address: YOUNG & THOMPSON, 745 SOUTH 23RD STREET, 2ND FLOOR, ARLINGTON, VA, 22202, US

(21) Appl. No.: 10/587,244

(22) PCT Filed: Jan. 27, 2005
(86) PCT No.: PCT/FR05/00173

§ 371 Date: Aug. 24, 2006

Related U.S. Application Data
(60) Provisional application No. 60/554,415, filed on Mar. 19, 2004.

(30) Foreign Application Priority Data
Jan. 27, 2004 (FR) 04 00744

(51) Int. Cl. H01R 9/22

(52) U.S. Cl. 439/715

(57) ABSTRACT

A device comprises osseous anchoring elements, one or two connecting rods (2) which are connectable to the anchoring elements and fixable to vertebrae by elements thereof and connecting elements (6, 3) of the rod(s) (2) for fixing the rod(s) to the anchoring elements, at least one anchoring element being of a polyaxial type. Each connecting part (6) and each base part (7) includes a transversal passage and a rigid transversal element (11, 24) whose direction is substantially perpendicular to the direction of the passage. The rigid transversal element (11, 24) of the connecting part (6) or of the base part (7) is introducible into the transversal passage of the base part (7) or of the connecting part (6) and vice-versa in such a way that the rigid transversal elements (11, 24) are pivotable in the passages.

The present invention relates to a vertebral osteosynthesis device.

A vertebral osteosynthesis device generally comprises bone anchoring elements, such as pedicular screws, clips or hooks, one or two connecting rods, intended to be connected to said anchoring elements and to be fixed to the vertebrae by means thereof, and connecting parts of said connecting rod(s) to said anchoring elements. The device may also comprise crosslinks of adjustable length, which connect two parallel connecting rods transversally to secure said rods with respect to each other.

In an existing type of device, each anchoring element comprises a threaded proximal slug whereon a nut may be fastened, and each connecting part comprises a rounded part intended to surround a connecting rod and two parallel wings perforated with holes. These wings are intended to be inserted onto said threaded proximal slug and to be fastened, by means of said nut, against a bearing surface provided on the anchoring element, said fastening inducing the fastening of said rounded part around the connecting rod and thus ensuring the longitudinal locking of said rod with respect to the anchoring element.

In another existing type of device, each anchoring element comprises a “tulip”-shaped connecting part, containing a housing wherein a connecting rod may be inserted.

The anchoring elements may be of the “polyaxial” type, i.e. enabling, before fastening, a joint of the threaded proximal slug or the “tulip” with respect to the base part of the anchoring element intended to come into contact with the bone. This joint facilitates the assembly of the connecting rods with the anchoring elements considerably.

In an existing “polyaxial” threaded proximal slug anchoring element, the joint is produced by providing a sphere at the end of the threaded proximal slug and a cavity in said base part, said cavity receiving the sphere and being closed again in the proximal part to hold said sphere.

In an existing “tulip” “polyaxial” anchoring element, said base part comprises a sphere around which the “tulip”-shaped connecting part is articulated.

These types of joint involve the drawback of only enabling limited clearance of the threaded proximal slug or the “tulip”, which may in some cases make it difficult to fit a rod on anchoring elements. Moreover and above all, the patient's movements result in movements of the threaded proximal slug or the “tulip” with respect to the base part, generating repeated friction of the sphere against the wall resting against said sphere. This results in a risk of undesirable diffusion of metal particles in the body, particularly as the surfaces rubbing against each other are relatively large.

In addition, the existing vertebral osteosynthesis devices are intended to lock two vertebrae together, to eliminate any relative movement of said vertebrae, or to restore the suitable position of one vertebra with respect to another. In order to obtain this locking, these devices are devised so as to ensure a perfectly rigid assembly of the connecting rods with the anchoring elements.

However, this rigid assembly may not always be desirable. It particularly induces the application of significant stress on the bone anchoring zones or said anchoring elements, along with increased stress on the vertebral joints located at either end of the treated vertebral segment, liable to result in degeneration of said joints. In addition, it is not suitable for non-degenerative conditions, particularly the treatment of scoliosis in young patients.

The present invention is intended to remedy all these drawbacks.

Therefore, its main aim is to provide a vertebral osteosynthesis device comprising at lease one polyaxial anchoring element, wherein the threaded proximal slug or the “tulip” of said anchoring element has a significant clearance with respect to the base part of the anchoring element intended to be fixed to the bone, and wherein the risk of metal diffusion in the body is significantly reduced with respect to an existing device.

Another aim of the invention is to provide a vertebral osteosynthesis device enabling a non-rigid, or flexible, assembly of the connecting rods with the anchoring elements, with damping of the movement of the moving parts if required.

The device in question comprises, in a manner that is known per se, bone anchoring elements, such as pedicular screws, clips or hooks, one or two connecting rods, intended to be connected to said anchoring elements and to be fixed to the vertebrae by means thereof, and connection means of said rod(s) to said anchoring elements, at least one of said anchoring elements being of the “polyaxial” type, i.e. comprising an articulated connecting part with respect to the base part of the anchoring device intended to be fixed to the vertebra.

According to the invention, said connecting part and said base part each comprise a transversal passage and a rigid transversal part which direction is substantially perpendicular to the direction of said passage, said rigid transversal part of the connecting part or base part being inserted in the transversal passage of the base part or connecting part, and vice versa, in such a way that these rigid transversal elements are pivotable in these passages.

In this way, the articulated connecting part may have a very significant clearance, up to 180 degrees, while this clearance does not exceed 30 degrees in an existing device. Moreover and above all, both rigid transversal elements have smaller mutual contact surfaces, limiting friction on the joint considerably. Consequently, this limitation of friction limits the risk of diffusion of metal particles in the patient's body to the same extent.

The term “connecting part” should be understood in a very broad sense: it may particularly consist of a threaded proximal slug or a “tulip”-shaped connecting part as described above; it may also consist of an end portion of a connecting rod.

Said transversal passage and said rigid transversal element of the connecting part or base part may also be made by providing a ring, the two rings of the connecting part and the base part being inserted into each other similarly to links in a chain.

Said transversal passage and said transversal element may also be provided in the form of two lateral lugs receiving a shaft through them, said lugs and shaft delimiting said passage and said shaft forming said rigid transversal element.

Said transversal passages and rigid transversal elements may be adjusted with respect to each other similarly to links in a chain; however, preferentially, each rigid transversal element comprises a rounded contact surface with the other rigid transversal element, the radius of curvature of said contact surface being greater than the radius of the cross-section of the other rigid transversal element.

In this way, this rounded contact surface enables a rolling movement of a rigid transversal element with respect to said contact surface of the other rigid transversal element, limiting the friction of one rigid transversal element on the other further.

The rigid transversal elements may come in direct contact with each other, or the anchoring element may comprise an intermediate part, inserted between said rigid transversal elements. In the first case, the rigid transversal elements may be made of a hard material with a low friction coefficient, or may comprise a coating, or have undergone a treatment, enabling them to have a high hardness and a low friction coefficient on their mutual contact zones. In the second case, said intermediate part may itself be made of a high hardness and low friction coefficient material.

Said intermediate part may particularly be formed so as to be retained between both rigid transversal elements by means of the shape of said rigid transversal elements.

According to another aspect of the invention, said “polyaxial” type anchoring element comprises at least one part or portion of a part with an elastically deformable structure, placed, after assembly, between said connecting part and said base part, said part or portion or part with an elastically deformable structure enabling mobility of the connecting part, and therefore of the connecting rod, with respect to base part, with damping.

In this way, in the device according to the invention, said connecting part is not locked with respect to the base part but may play with respect thereto, to allow limited vertebral movements. In this way, the stress applied by the anchoring element on the bone anchoring zones is considerably reduced, along with the risks of excessive stress on the vertebral joints located at either end of the vertebral segment treated.

The base part may comprise a part with an elastically deformable structure and the connecting part may comprise another part with an elastically deformable structure, said two parts supporting each other in the assembly position.

Said connecting part may comprise a curved bearing surface, suitable for resting against a corresponding curved bearing surface of said base part and sliding against said surface during movements of said connecting part with respect to said base part. In particular, said connecting part may comprise a convex peripheral surface, in the form of a spherical cap, and said base part may comprise a corresponding concave peripheral surface.

The invention will be understood clearly and other characteristics and advantages thereof will emerge with reference to the appended figure representing, as non-limitative examples, two possible embodiments comprised by the related device.

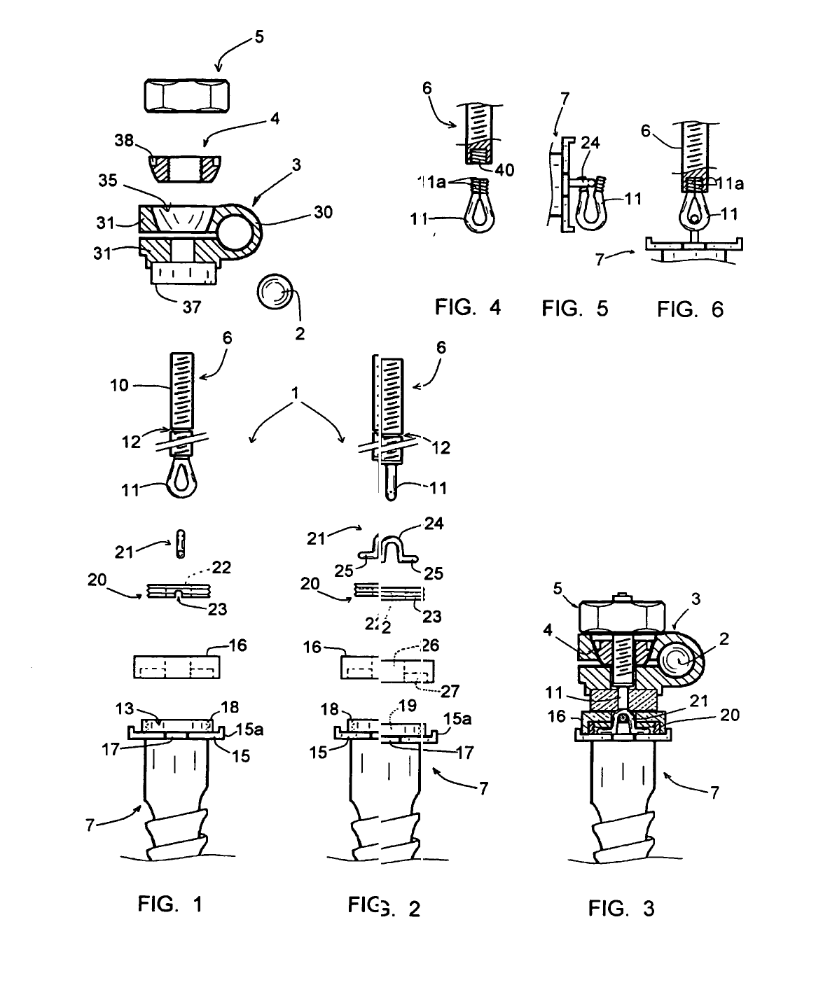

FIG. 1 is a side view, before assembly, of parts forming a polyaxial pedicular screw according to the invention, according to a first embodiment; this figure also shows a connecting rod, a connecting clamp in a cross-sectional view, and two nuts used to assemble a connecting rod with this screw;

FIG. 2 is a view of said parts similar to FIG. 1 but along a direction perpendicular to the view in FIG. 1;

FIG. 3 is a view of the parts shown in FIG. 1, after assembly;

FIG. 4 is a side view, before assembly, of two parts used to form a polyaxial pedicular screw according to the invention, according to the second embodiment;

FIG. 5 is a side view of two parts used to form the polyaxial pedicular screw, during assembly, and FIG. 6 is a side view of three parts used to form the polyaxial pedicular screw, after assembly.

FIGS. 1 and 2 representing a polyaxial pedicular screw 1, a rod 2 connecting several of these screws 1, a clamp 3 connecting said rod 2 to one of these screws 1 and two nuts 4, 5 used to assemble the connecting rod 2 to this screw 1.

The screw 1 comprises a threaded proximal slug 6 and a threaded distal screw body 7. The slug 6 is intended to receive the clamp 3 inserted thereon and the nuts 4, 5 screwed thereon while the body 7 is intended to be inserted in the pedicle of a vertebra.

The slug 6 comprises a threaded cylindrical part 10, a distal ring 11 and a zone 12 of reduced diameter, making it possible to break its proximal portion after the positioning and fastening of the nut 5, as seen by comparing FIGS. 1 and 3.

The body 7 comprises a proximal collar 15, provided with a peripheral rim 15a, said collar 15 delimiting a reception housing for a washer 16 made of a material with an elastically deformable structure, particularly silicone or PMMA. This washer 16 enables, after assembly, damping of the movement of the slug 6 with respect to the body 7, as described below.

The collar 15 also comprises several radial notches 17, in particular four notches at 90° with respect to each other, used to hold the body 7 in rotation during the fastening of the nuts 4 and 5.

The body 7 also comprises a proximal cylindrical wall 18, delimiting a threaded bore 19.

The screw I also comprises a threaded washer 20 and an omega-shaped part 21.

The threaded washer 20 comprises a central hole 22 used to insert the slug 6 and the ring 11, and a lower diametrical groove 23.

The omega-shaped part 21 comprises a central part 24 that can be inserted into the ring 11 and can be inserted into the hole 22 of the washer 20, and two lateral arms 25 that can be received in the groove 23.

Understandably, the slug 6 is assembled with the body 7 by inserting the central part 24 of the part 21 into the ring 11, inserting the washer 20 on the slug 6 and the ring 11 until said central part 24 is inserted in the hole 22 and said arms 25 are inserted in the groove 23, and fastening the washer 20 firmly in the threaded bore 19. For the fastening thereof, said washer 20 comprises cavities (not shown) opening into its proximal face.

The washer 16 is then positioned on the collar 15, said washer comprising a central hole 26 enabling its insertion on the slug 6 and the ring 11 and a recess 27 receiving the wall 18.

For the other parts shown in FIG. 1, the connecting rod 2 is cylindrical and displays a rigidity such that it enables the support of several vertebrae with respect to each other. However, said rod 2 is deformable so as to be able to be adapted according to the spinal correction required.

The clamp 3 comprises a rounded part 30 intended to surround the connecting rod 2 and two parallel lateral wings 31 perforated with holes to insert the clamp 3 on the slug 6. Said wings 31 are mutually distant such that, in a separation position, the rod 2 can be inserted and can slide in the part 30, and that, in a closing position provided by the fastening of the nut 5, they clamp the part 30 around the rod 2, locking the rod with respect to the clamp 3.

As shown in FIG. 1, the proximal wing 31 comprises a proximal trough 35 of a suitable shape to receive the nut 4 without axial support, while the distal wing 31 comprises a circular wall 36 forming a housing to receive a washer 37 with an elastically deformable structure, particularly made of silicone or PMMA, capable of cooperating with the washer 16 to damp the movement of the slug 6 with respect to the screw body 7.

The nut 4 comprises peripheral notches 38 to adjust it in rotation. It is designed to rest only against the distal arm 31 of the clamp 3 when fastened.

The nut 5 is designed to rest against the proximal arm 31 of the clamp 3 when fastened.

In practice, the number of screws 1 required for the treatment to be carried out are fitted in the pedicles of the vertebrae concerned, and the clamps 3, with the rod 2 inserted in the parts 30, are placed on the slugs 6.

The nut 4 is then fastened in a controlled manner, for example using a dynamometric screwdriver, to produce variable fastening of the washers 16 and 37, according to the desired degree of damping according to the patient's characteristics (condition of intervertebral disks, degree of vertebral instability, weight), and the nut 5 is fastened to bring the arms 31 closer together and thus fasten the shaft 2 in the part 30 of the clamp 3.

Each clamp 3 may comprise a graduation engraved thereon around the cavity 35 and the nut 4 may comprise a mark engraved thereon, said mark cooperating with said graduation to enable the controlled fastening of the nut 4.

The proximal portions of the slugs 6 are then divided.

FIGS. 4 to 6 represent a second embodiment of the invention. The parts or portions in identical or similar positions are referred to with the same numeric references.

In this second embodiment, the screw body 7 comprises a fixed ring 24, and the ring 11 ends, at the proximal end, with two arms 11a in contact with each other. The end portions of these arms 11a have a semi-cylindrical shape and are threaded so as to form, in this contact position, a continuous thread.

The slug 6 comprises a threaded bore 40 opening into its distal face.

As demonstrated in FIG. 5, both arms 11a can be separated by elastic deformation of the ring 11 to enable the insertion of the ring 24 inside the ring 11. Once this insertion has been completed, both arms 11a are again in contact and the ring 11 can be fastened and locked in the bore 40.

As can be seen above, the invention provides a vertebral osteosynthesis device wherein the slug 6 has a significant clearance with respect to the body 7, and wherein the risk of diffusion of metal in the body is significantly reduced with respect to an existing device, in view of the smaller contact surfaces of rings 11 and 24.

The invention also provides a vertebral osteosynthesis device enabling a non-rigid assembly of the connecting rods 2 with the anchoring elements 1.

Naturally the invention is not limited to the embodiment described above as an example but is extended to all embodiments covered by the appended claims.

In particular, the term “ring” should be understood in the broadest sense, as being an assembly part defining an opening and a junction zone, the junction zone of a ring being capable of being inserted into the other ring and vice versa, such that the junction zones of both rings can rest against each other and assemble said base part with said connecting part (threaded proximal slug or “tulip”).

In this way, the scope of the invention would not be departed from:
by making one of the two rings open, to enable the interpenetration of both rings and closing the open ring, particularly by welding said ring to the part comprising it;
by making one of the two rings open, or both rings open;
by making one of the two rings in the form of a cap receiving a pin.

The term “articulated connecting part” should also be understood in a broad sense: it may consist of a threaded proximal slug 6 as described above, a “tulip”-shaped connecting part, comprising a housing wherein a connecting rod 2 may be inserted, or the end portion of a connecting rod.

1. Vertebral osteosynthesis device, comprising bone anchoring elements, such as pedicular screws (1), clips or hooks, one or two connecting rods (2), intended to be connected to said anchoring elements and to be fixed to the vertebrae by means thereof, and connection means (6, 3) of said rod(s) (2) to said anchoring elements (1), at least one of said anchoring elements (1) being of the “polyaxial” type, i.e. comprising an articulated connecting part (6) with respect to the base part (7) of the anchoring device (1) intended to be fixed to the vertebra;
characterized in that said connecting part (6) and said base part (7) each comprise a transversal passage and a rigid transversal part (11, 24) which direction is substantially perpendicular to the direction of said passage, said rigid transversal part (11, 24) of the connecting part (6) or of the base part (7) being inserted in the transversal passage of the base part (7) or of the connecting part (6), and vice versa, in such a way that these rigid transversal elements (11, 24) are pivotable in these passages.

2. Device according to claim 1, characterized in that said transversal passage and said rigid transversal element (11, 24) of the connecting part (6) or of the base part (7) are made by providing a ring (11) on the connecting part (6) and a ring (24) on the base part (7), the two rings (11) of the connecting part (6) and the base part (7) being inserted into each other similarly to links in a chain.

3. Device according to claim 1, characterized in that each rigid transversal element (11, 24) comprises a rounded contact surface with the other rigid transversal element (11, 24), the radius of curvature of said contact surface being greater than the radius of the cross-section of the other rigid transversal element (11, 24).

4. Device according to claim 1, characterized in that the anchoring element comprises an intermediate part, inserted between said rigid transversal elements (11, 24).

5. Device according to claim 3, characterized in that the rigid transversal elements are made of a hard material with a low friction coefficient, or comprise a coating, or have undergone a treatment enabling them to have a high hardness and a low friction coefficient on their mutual contact zones, or in that said intermediate part is itself be made of a high hardness and low friction coefficient material.

6. Device according to claim 4, characterized in that said intermediate part is particularly formed so as to be retained between both rigid transversal elements by means of the shape of said rigid transversal elements.

7. Device according to claim 1, characterized in that said “polyaxial” type anchoring element (1) comprises at least one part (16, 37) or portion of a part with an elastically deformable structure, placed, after assembly, between said connecting part (6, 3) and said base part (7), said part (16, 37) or portion or part with an elastically deformable structure enabling mobility of the connecting part (6, 3), and therefore of the connecting rod (2), with respect to base part (7), with damping.

8. Device according to claim 7, characterized in that said base part (7) comprises a part (16) with an elastically deformable structure and the connecting part (3) comprises another part (37) with an elastically deformable structure, said two parts (16, 37) supporting each other in the assembly position.

9. Device according to claim 1, characterized in that said connecting part comprises a curved bearing surface, suitable for resting against a corresponding curved bearing surface of said base part and sliding against said surface during movements of said connecting part with respect to said base part.

10. Device according to claim 9, characterized in that said connecting part comprises a convex peripheral surface, in the form of a spherical cap, and said base part comprises a corresponding concave peripheral surface.

11. Device according to claim 2, characterized in that each rigid transversal element (11, 24) comprises a rounded contact surface with the other rigid transversal element (11, 24), the radius of curvature of said contact surface being greater than the radius of the cross-section of the other rigid transversal element (11, 24).

12. Device according to claim 2, characterized in that the anchoring element comprises an intermediate part, inserted between said rigid transversal elements (11, 24).

13. Device according to claim 4, characterized in that the rigid transversal elements are made of a hard material with a low friction coefficient, or comprise a coating, or have undergone a treatment enabling them to have a high hardness and a low friction coefficient on their mutual contact zones, or in that said intermediate part is itself be made of a high hardness and low friction coefficient material.

14. Device according to claim 5, characterized in that said intermediate part is particularly formed so as to be retained between both rigid transversal elements by means of the shape of said rigid transversal elements.
